(19) United States
(12) Patent Application Publication
(10) Pub. No.: US 2011/0121061 A1
(43) Pub. Date: May 26, 2011

(54) CARTON, CARTON BLANK AND METHOD OF CONSTRUCTION THEREFOR

(76) Inventor: Philippe LeBras, Chateauroux (FR)

(21) Appl. No.: 13/003,520

(22) PCT Filed: Jul. 6, 2009
(86) PCT No.: PCT/US09/49674

§ 371 Date: Feb. 7, 2011

(30) Foreign Application Priority Data
Jul. 10, 2008 (GB) 0812566.8
Dec. 18, 2008 (GB) 0823079.9

(51) Int. Cl. B65D 5/42; B31B 1/74; B31B 1/62; B32B 3/00

(52) U.S. Cl. 229/160.1; 229/126; 229/198; 493/84; 493/128; 493/162

(57) ABSTRACT

A carton, blank and method for packaging articles the carton comprising a plurality of main panels (30, 40, 50, 60) for forming a top panel (40), a first side wall (50), second side wall (60) and bottom panel (30) hinged together to form a tubular structure wherein a first panel (60) of said plurality of main panels is hinged to a securing panel (20) and a second panel (30) of said plurality of main panels comprises a hinged panel (10) struck therefrom said hinged panel being foldable out of the plane of the second panel for facilitating alignment of said second panel with respect to the securing panel and for facilitating securing the hinged panel to the securing panel.

### BACKGROUND OF THE INVENTION

The invention relates to a carton for packaging one or more articles, a blank for forming said carton and a method of constructing the carton from the carton blank. More particularly, but not exclusively, the invention relates to a method of securing the carton blank in a tubular structure about a group of one or more articles.

In the field of packaging, it is often required to provide consumers with a package comprising multiple primary product containers. Such “multi-packs” are desirable for shipping and distribution and for display of information and advertising. Such “multi-packs” also provide consumers with a convenient means for transporting and storing multiple primary product containers.

A wraparound-style carton is known as one of the package styles for providing multi-packs. A typical wraparound carton is provided with a mechanical lock or locks for securing together two adjoining panels of the carton. Such mechanical locks are also convenient for aligning the adjacent panels with each other so that the assembled carton can properly retain multiple articles. Adhesive may replace mechanical locks to secure such adjacent panels. Those wraparound cartons in which adjacent panels are adhesively secured are flexible in one sense in that they have a higher tolerance to articles of different sizes than those with mechanical locks. Adhesively assembled wraparound cartons require a packaging machine of a less complicated construction since they do not require a locking device for handling the locks. One drawback of adhesively assembled wraparound cartons is that alignment of two adjacent panels is not always easy.

What is needed therefore is a carton and a carton blank that have means for facilitating alignment of two adjacent panels while the adjacent panels are adhesively secured together.

### SUMMARY OF THE INVENTION

According to a first embodiment of the present invention there is provided a carton for packaging articles comprising a plurality of main panels hinged together to form a tubular structure wherein said main panels include first and second adjoining panels, said first panel is hinged to a securing panel and said second panel comprises a hinged panel struck therefrom and hingedly connected thereto, said hinged panel being foldable out of the plane of the second panel for facilitating alignment of said second panel with respect to the securing panel and for facilitating securing the hinged panel to the securing panel wherein adhesive is applied to the securing panel whereby securing the carton in an erected condition.

Preferably, the securing panel is adhesively secured to the hinged panel only.

Preferably, edges of the second panel provide a positioning device for aligning the first panel with the second panel.

Preferably, the hinged panel is substantially trapezoidal in shape. Alternatively, the hinged panel is substantially hexagonal in shape.

Preferably, the carton comprises a series of end closure panels hinged to opposed ends of each of the plurality of main panels for closing each end of the tubular structure.

Preferably, the carton comprises a beam forming panel hinged to each of a pair of opposing end closure panels at each end of the tubular structure.

Preferably, the securing panel is hingedly connected to the first panel along a first fold line, the hinged panel is hingedly connected to the second panel along a second fold line, and the first fold line is substantially greater in length than the second fold line.

Preferably, the hinged panel is struck from the second panel such that at least one guide edge is provided by the second panel, said at least one guide edge is disposed substantially in the plane of the first panel.

Preferably, said at least one guide edge is disposed in substantial alignment with a fold line along which said securing panel is hinged to said first panel.

Preferably, said at least one guide edge is substantially parallel to a fold line along which said hinged panel is connected to said second panel.

Preferably, said at least one guide edge comprises a pair of spaced guide edges, and said hinged panel is interposed between said pair of spaced guide edges.

Preferably, said hinged panel is connected to said second panel along a fold line, said pair of spaced guide edges are connected to said fold line by a pair of divergent edges of said second panel that are defined at least in part by said hinged panel.

According to a second aspect of the present invention there is provided a blank for forming a carton comprising a plurality of main panels for forming a top panel, a first side wall, second side wall and bottom panel hinged together to form a tubular structure in a setup carton wherein a first panel of said plurality of main panels is hinged to a securing panel and a second panel of said plurality of main panels comprises a hinged panel struck therefrom said hinged panel being foldable out of the plane of the second panel for facilitating alignment of said second panel with respect to the securing panel and for facilitating securing the hinged panel to the securing panel.

Preferably, the hinged panel is substantially trapezoidal in shape. Alternatively, the hinged panel is substantially hexagonal in shape.

Preferably, the blank comprises a series of end closure panels hinged to opposed ends of each of the plurality of main panels for closing each end of the tubular structure.

Preferably, the blank comprises a beam forming panel hinged to each of the end closure panels hinged to the panels for forming the first side wall and second side wall.

According to a third aspect of the present invention there is provided a method of constructing carton about a group of one or more articles to form a package comprising:
lowering a blank as hereinbefore described onto a group of one or more articles such that the top panel is brought into contact with an upper surface of said group of one or more articles;
folding the first side wall and the second side wall about the sides of said group of one or more articles into a substantially inverted U-shaped structure;
folding the securing panel about the base of the group of one or more articles;
folding the hinged panel out of the plane of the bottom panel;
folding the bottom panel about the base of the group of one or more articles;
aligning the bottom panel with respect to the securing panel;
conditioning the securing panel or the hinged panel such that the hinged panel is secured to the securing panel;
folding the hinged panel back into the plane of the bottom panel to be brought into contact with the securing panel thereby securing the main panels of the blank in tubular structure.

Preferably, the process of conditioning the securing panel comprises application of adhesive material to the securing panel or the hinged panel.

Alternatively, the process of folding the first side wall and the second side wall into a substantially inverted U-shaped structure is performed prior to lowering the blank onto the group of one or more articles.

Preferably, open ends of the tubular structure are at least partially closed by folding the end closure panels to be substantially perpendicular with the respective one of said plurality of main panels to which they are hinged.

Preferably, the beam forming panels are folded to be substantially perpendicular with respective the end closure panels to which they are hinged such that when said respective end closure panels are folded about the open ends of the tubular structure the beam forming panels are inserted between a pair of adjacent articles at each end of the package.

Preferably, folding of said hinged panel out of the plane of the bottom panel creates a window through which adhesive may be applied to the hinged panel.

According to a fourth aspect of the present invention there is provided a method of constructing carton about a group of one or more articles to form a package, the carton being formed from a blank comprising a securing panel, a first side wall, a top panel, a second side wall and a bottom panel hinged together in the recited sequence, the bottom panel including a hinged panel struck therefrom and hinged thereto, the method comprising:
folding the bottom panel to be substantially perpendicular to the first side wall;
folding the hinged panel out of the plane of the bottom panel;
lowering a group of one or more articles onto the base panel of said blank;
folding the top panel and the second side wall about the group of one or more articles
folding securing panel about the base of the group of one or more articles;
aligning the bottom panel with respect to the securing panel;
conditioning the securing panel or the hinged panel such that the hinged panel is secured to the securing panel;
folding the hinged panel back into the plane of the bottom panel to be brought into contact with the securing panel thereby securing the main panels of the blank in a tubular structure.

Preferably, the hinged panel is folded into a substantially vertical orientation for application of adhesive thereto.

Preferably, adhesive is applied such that only the hinged panel is secured to the glue flap.

### BRIEF DESCRIPTION OF THE DRAWINGS

Exemplary embodiments of the invention will now be described with reference to the accompanying drawings, in which:

FIG. 1 is a plan view of a blank for forming a carton according to a first embodiment of the invention;

FIG. 2 is a perspective view from below of first stage of construction of the blank of FIG. 1 into a carton;

FIG. 3 is a perspective view from below of second stage of construction of the blank of FIG. 1 into a carton;

FIG. 4 is a perspective view from below of third stage of construction of the blank of FIG. 1 into a carton;

FIG. 5A is a perspective view from below of fourth stage of construction of the blank of FIG. 1 into a carton;

FIG. 5B is a perspective view from below of fifth stage of construction of the blank of FIG. 1 into a carton;

FIG. 6A is a perspective view from below of sixth stage of construction of the blank of FIG. 1 into a carton;

FIG. 6B is a perspective view from below of seventh stage of construction of the blank of FIG. 1 into a carton;

FIG. 7 is a plan view of a blank for forming a carton according to a second embodiment of the invention;

FIG. 8 is a plan view of a blank for forming a carton according to a third embodiment of the invention;

FIG. 9A is a perspective view of a first stage of an alternative method of assembly of the carton according to a third embodiment of the invention;

FIG. 9B is a perspective view of a second stage of an alternative method of assembly of the carton according to a third embodiment of the invention;

FIG. 9C is a perspective view of a third stage of an alternative method of assembly of the carton according to a third embodiment of the invention;

FIG. 9D is a perspective view of a fourth stage of an alternative method of assembly of the carton according to a third embodiment of the invention; and

FIG. 9E is a perspective view of a fifth stage of an alternative method of assembly of the carton according to a third embodiment of the invention.

### DETAILED DESCRIPTION OF THE PREFERRED EMBODIMENTS

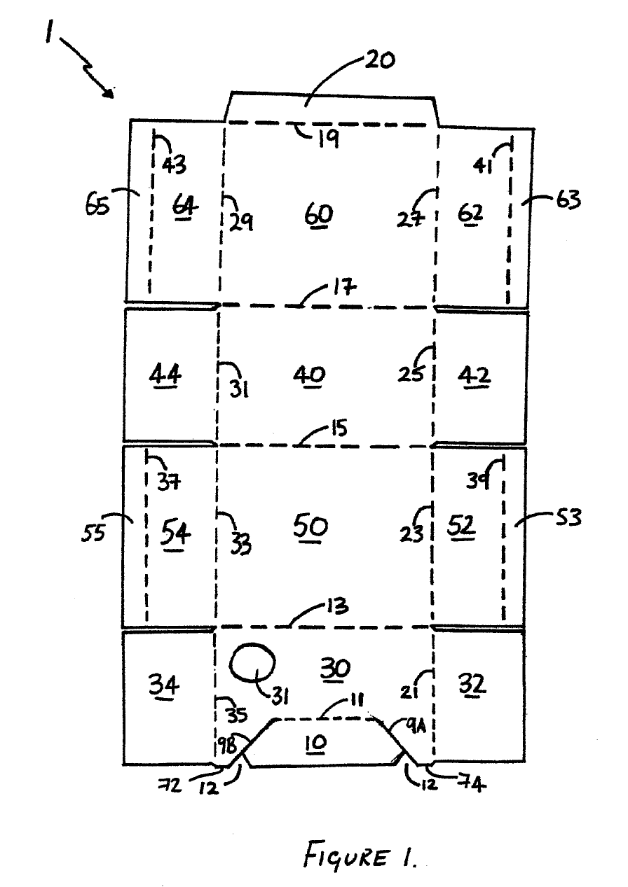

Referring to FIG. 1, there is shown a plan view of a blank 1 for forming a carton. Blank 1 comprises a series of main panels 30, 40, 50, 60 for forming a bottom panel 30, a first side wall 50, a top panel 40 and a second side wall 60 hinged in a linear series one to the next by fold lines 13, 15, 17 respectively.

Blank 1 also comprises a pair of bottom end closure flaps 32, 34 hinged to the opposed end edges of bottom panel 30 by fold lines 21 and 35 respectively. Likewise, a pair of top end closure flaps 42, 44 are provided hinged to the opposed end edges of top panel 40 by fold lines 25 and 31 respectively.

First side wall end flaps 52, 54 are hinged along opposing end edges, by fold lines 23 and 33 respectively, to first side wall 50. First side end flap 52 is hingedly connected to a first beam forming panel 53 by fold line 39 along an end edge opposing fold line 23. First side end flap 54 is hingedly connected to a second beam forming panel 55 by fold line 37 along an end edge opposing fold line 33.

Second side wall end flaps 62, 64 are hinged along opposing end edges, by fold lines 27 and 29 respectively, to second side wall 60. Second side end flap 62 is hingedly connected to a third beam forming panel 63 by fold line 41 along an end edge opposing fold line 27. Second side end flap 64 is hingedly connected to a fourth beam forming panel 65 by fold line 43 along an end edge opposing fold line 29.

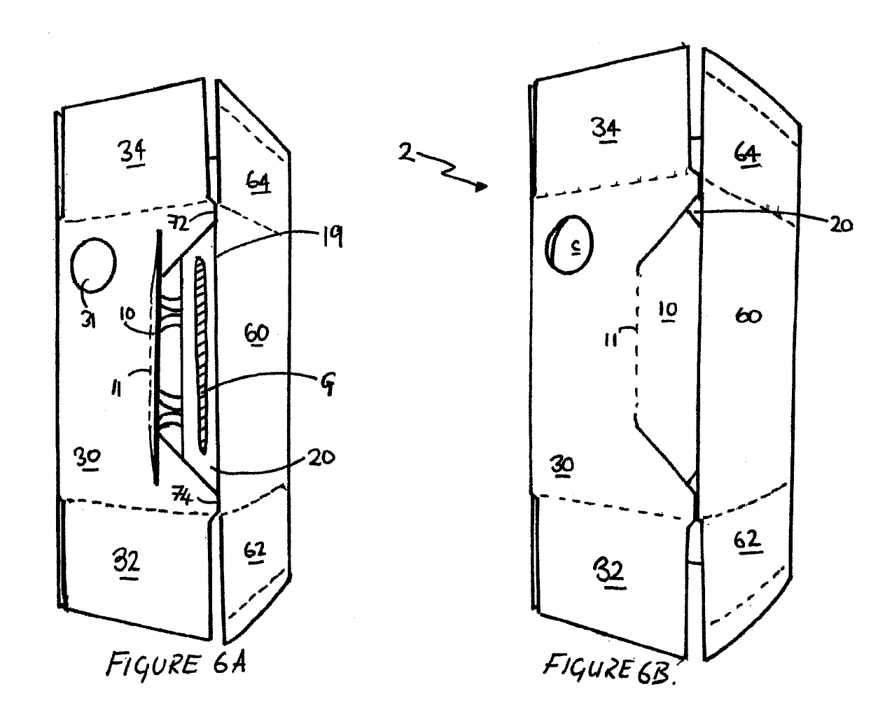

Bottom panel 30 comprises an aperture 31. Aperture 31 provides a means for visibly inspecting the base of an article C (FIG. 6B) packaged in a carton formed from blank 1. Bottom panel 30 also comprises a hinged panel 10 struck from bottom panel 30. Hinged panel 10 is defined in part by fold line 11 and in part by cut-lines 9A and 9B divergently extending from each other from the opposite ends of fold line 11. Preferably, hinged panel 10 has a substantially trapezoidal shape. Optionally, the hinged panel 10 comprises a recess disposed adjacent an end of each of cut-lines 9A and 9B, such that hinged panel 10 is hexagonal in shape. The hinged panel 10 is struck from the bottom panel 30 such that a guide edge 72, 74 is provided by the bottom panel 30. The guide edge 72, 74, when the carton is constructed, is disposed substantially in the plane of the second side wall 60 and also in substantial alignment with the fold line 19 along which the securing panel 20 is hinged to the second side wall 60. The guide edges 72, 74 are used as a positioning device to facilitate alignment of the panels 20, 30 (and/or the panels 30, 60) of the carton during assembly.

The guide edge 72, 74 is substantially parallel to the fold line 11 along which said hinged panel 10 is connected to the bottom panel 30.

In one embodiment of the invention, the guide edge 72, 74 comprises a pair of spaced guide edges 72, 74, and said hinged panel 10 is interposed between said pair of spaced guide edges 72, 74.

The hinged panel 10 is connected to the bottom panel 30 along the fold line 11 and the pair of spaced guide edges 72, 74 are connected to the fold line 11 by a pair of divergent edges formed by cut-lines 9A and 9B in the bottom panel 30.

Securing panel 20 is provided for securing second side wall 60 to bottom panel 30. Second side wall 60 is hinged to securing panel 20 by a fold line 19 opposing fold line 17 which hinges second side wall 60 to the top panel 40.

It should be noted that in the exemplary embodiments, the glue flap or securing panel 20 is hingedly connected to the second side wall 60 along the fold line 19 and that the hinged panel 10 is hingedly connected to the bottom panel 30 along fold line 11. The fold line 19 is substantially greater in length than the fold line 11.

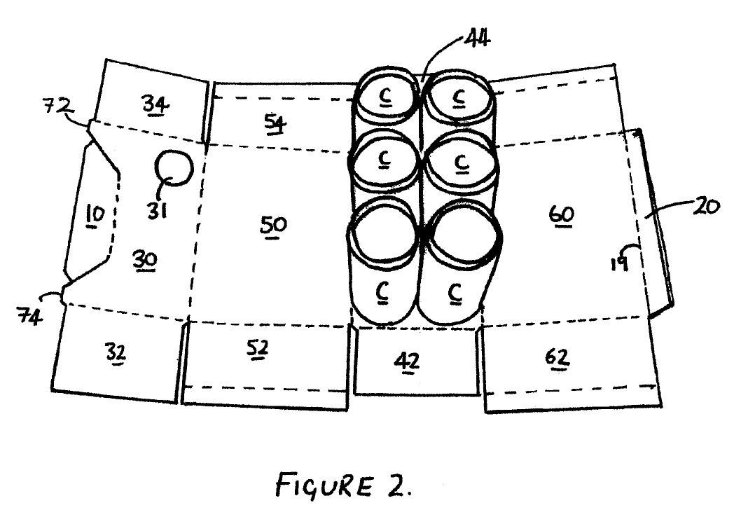

Turning to the construction of the carton as illustrated in FIGS. 2 to 6B, it is envisaged that the carton can be formed by a series of sequential folding operations which can be performed in a straight line machine so that the carton is not required to be rotated or inverted to complete its construction. The folding process is not limited to that described below and may be altered according to particular manufacturing requirements.

In FIG. 2, the blank 1 is lowered in a flat unfolded form onto a group of articles C, for example beverage cans or bottles.

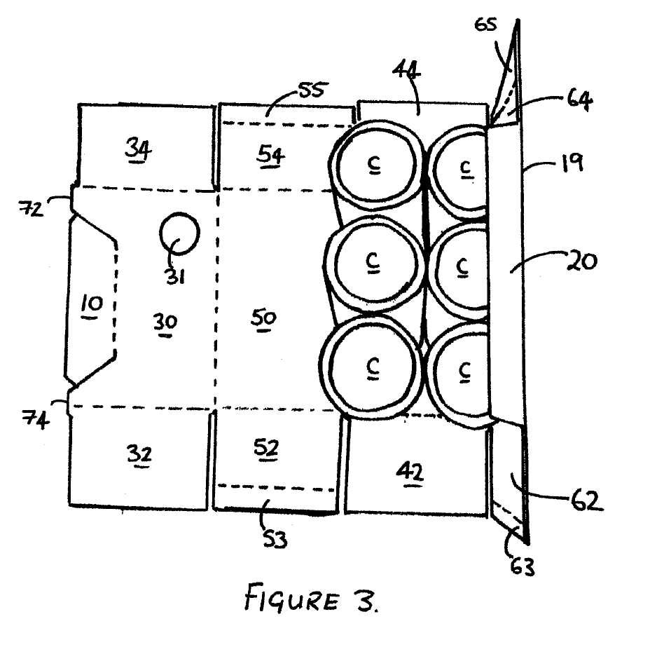

Once blank 1 is lowered onto the group of articles C (or the group of articles C is lowered onto the blank 1), the second side wall 60 is folded about fold line 17 into substantially perpendicular relationship with top panel 40. Securing panel 20 is then folded about the base of the group of articles C to be in perpendicular relationship with second side wall 60, as shown in FIG. 3.

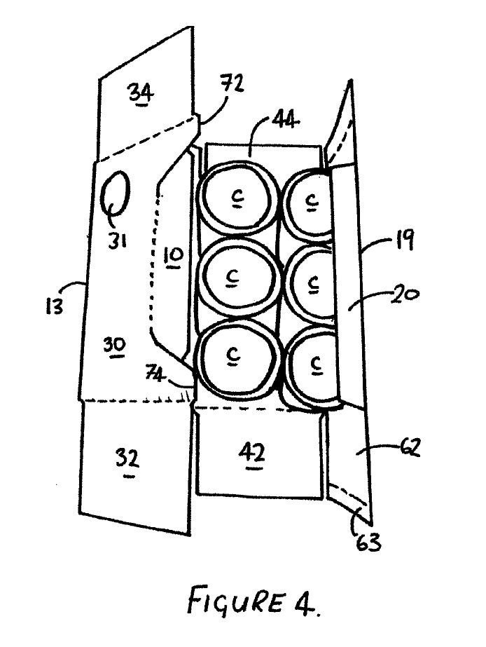

First side wall 50 is then folded about fold line 15 into substantially perpendicular relationship with top panel 40, as shown in FIG. 4.

In an alternative embodiment, it is envisaged that the blank could be offered up to the group of articles in a substantially U-shaped configuration where first side wall 50 and second side wall 60 are folded about fold line 15 and 17 respectively into a substantially perpendicular relationship with top panel 40 prior to blank 1 being lowered onto the group of articles C.

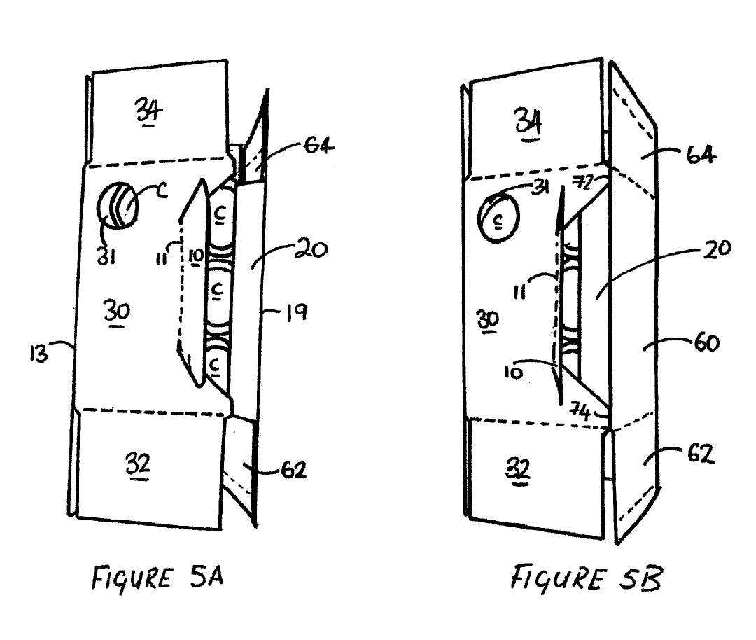

Bottom panel 30 is then folded about fold line 13 towards the base of the group of articles C. This is performed prior to, subsequent to, or even simultaneously with folding the hinged panel 10 about fold line 11 out of the plane of bottom panel 30. The hinged panel 10 is folded out of the plane to expose a portion of the securing flap 20, facilitating alignment of the bottom panel 30 with respect to the securing panel 20 as shown in FIGS. 5A and 5B. In this way the hinged panel 10 when folded out of the plane of the bottom panel 30 creates a window through which glue is applied to the area of the securing panel 20 exposed by the window.

Glue or other adhesive material G is then applied to securing panel 20 as illustrated in FIG. 6A. Alternatively, glue is applied to the hinged panel 10 and preferably glue is applied to the hinged panel 10 only. Hinged panel 10 is then folded about fold line 11 back into a planar relationship with bottom panel 30. A compressive force may be applied as necessary to secure hinged panel 10 to securing panel 20; thus a tubular structure 2 is formed about the group of articles C.

The construction of the carton is completed by folding the first, second, third and fourth beam forming panels 53, 55, 63, 65 to be substantially perpendicular with the first and second side end flaps 52, 54, 62, 64 respectively. The beam forming panels 53, 55, 63, 65 are then inserted between a pair of adjacent endmost articles C in the group of articles C by folding the first and second side end flaps 52, 54, 62, 64 to be substantially perpendicular with the respective first or second side wall 50, 60 to which they are hinged. The beam forming panels 53, 55, 63, 65 provide additional strength to the carton. It is envisaged that in alternative embodiments the beam forming panels 53, 55, 63, 65 may be omitted.

The top and bottom end closure flaps 42, 44, 32, 34 are then folded and glued to the outside surfaces of the side end flaps 52, 62, 54, 64 to keep the opposite ends of the carton closed.

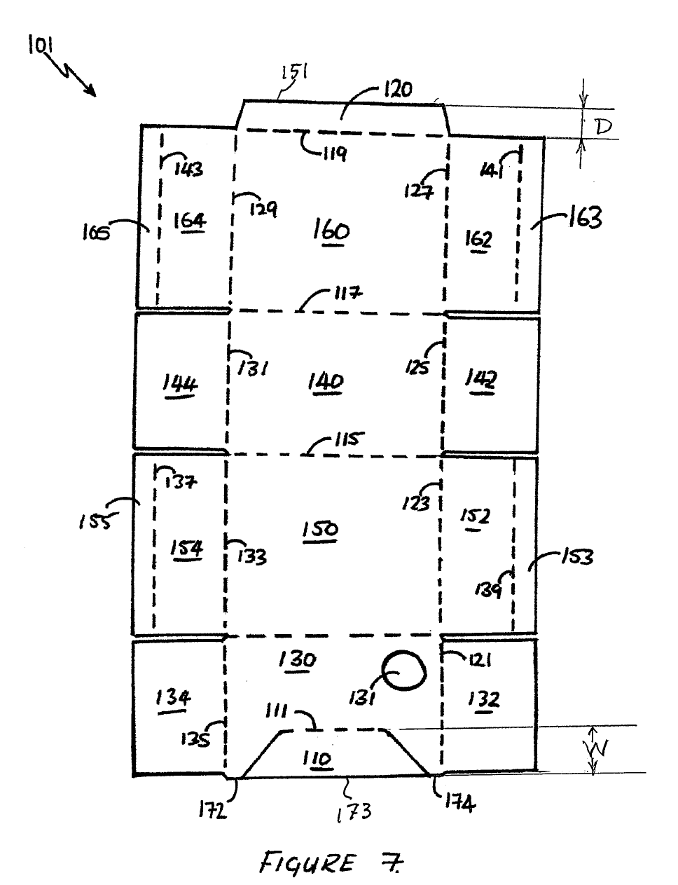

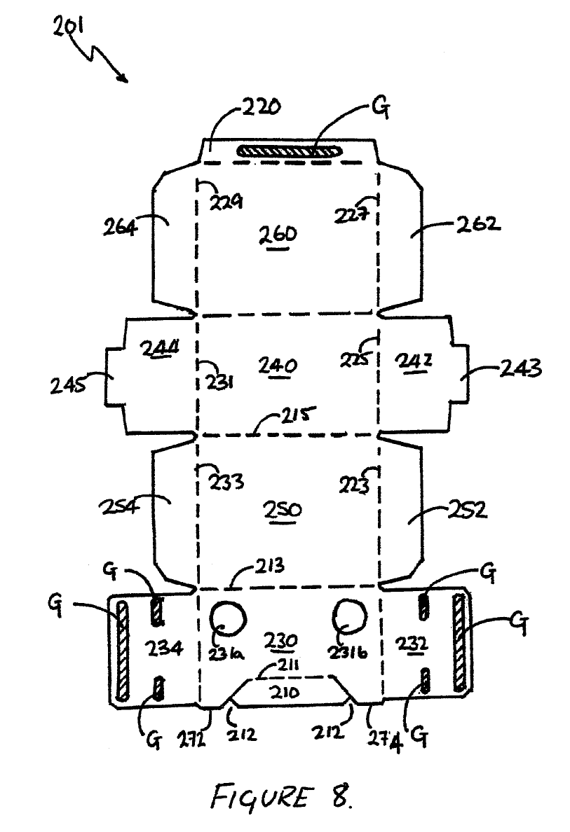

Referring now to FIG. 7 and FIG. 8, alternative embodiments of the present invention are illustrated in which like numerals have, where possible, been used for like parts, with the addition of the prefix “1” and “2” and therefore only the differences from the embodiment illustrated in FIGS. 1 to 6B will be described in any greater detail.

FIG. 7 illustrates a blank 101 in which the hinged panel 110 is trapezoidal in shape; the recesses 12 (FIG. 1) have been omitted. It should also be noted that the position of aperture 131 has been changed.

FIG. 8 illustrates a blank 201 in which the beam forming panels are omitted; it will be noticed that the bottom panel is now provided with two apertures 231.

The top end closure flaps 242 and 244 have been adapted such that when folded about the fold lines 225 and 231 respectively, a central portion 243, 245 of the top end closure flaps 242, 244 overlaps with the corresponding bottom end closure flap 232, 234. In this way a single application of glue or other adhesive G can be applied to the bottom end closure flap 232, 234 substantially across the entire width of the bottom end closure flaps 232, 234 such that the bottom end closure flaps 232, 234 may be secured to the respective ones of the top end closure flaps 242, 244 the first side wall end flaps 252, 254 and the second side wall end flaps 262, 264 simultaneously. Additional glue or adhesive G is applied to the bottom end closure flaps 232, 234 to secure the first side wall end flaps 252, 254 and the second side wall end flaps 262, 264 at a second position to the bottom panel 230.

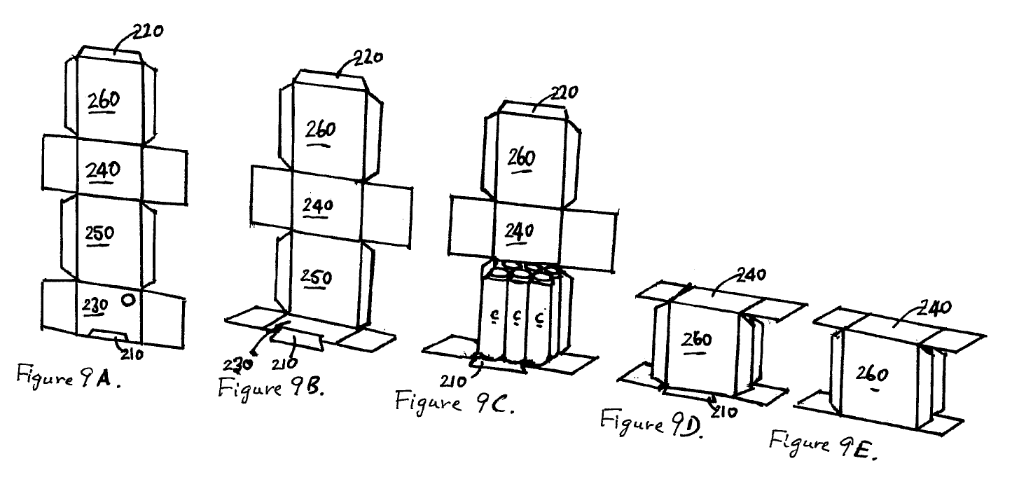

In an alternative embodiment it is envisaged that the carton may be assembled by folding as illustrated in FIG. 9A to 9E. The bottom panel 230 is folded to be substantially perpendicular to the first side wall 250, as shown in FIG. 9B. Hinged panel 210 is folded out of the plane of the bottom panel 230, preferably to be substantially perpendicular to bottom panel 230, as shown in FIG. 9B.

It is envisaged that in one embodiment of the invention, the hinged panel 210 is folded such that it is in a substantially vertical orientation such that glue may be applied to the hinged panel 210 in that orientation using a gluing apparatus forming part of a packaging machine.

Articles C are then loaded onto bottom panel 230, as illustrated in FIG. 9C. Top panel 240 and second side wall 260 are then folded about the articles C, as shown in FIG. 9D. Securing panel 220 is folded perpendicular to second side wall 260 and placed in contacting relationship with an internal face of bottom panel 230. Guide edges 272, 274 provide a positioning device to facilitate alignment of the carton; the fold line 219 is aligned with the guide edges 272, 274 such that the bottom panel 230 and second side wall 260 are in alignment.

Glue is then applied to hinged panel 210, and then hinged panel 210 is folded back into the plane of the bottom panel 230 as shown in FIG. 9E, such that it is brought into contact with securing panel 220. This secures the hinged panel 210 to the securing panel 220 thereby securing the carton in an erected condition. It will be appreciated that the glue or other adhesive is applied such that only the hinged panel 210 is secured to the securing panel 220.

In yet a further alternative embodiment, it is envisaged that the securing panel 220 may be folded such that it is brought into contact with an external face of the bottom panel 230. Glue is then applied to the hinged panel 210 which is subsequently folded into contacting relationship with the securing panel 220 such that the securing panel 220 is sandwiched between the hinged panel 210 and the bottom panel 230. In all the embodiments described, the guide edges 272, 274 provide a positioning means to facilitate alignment of the second side wall 260 with the bottom panel 230 wherein the fold line between the second side wall 260 and the securing panel 220 is aligned with the guide edges 272, 274. Whilst this alternative method of construction has been described with reference to the embodiment of FIG. 8, it is envisaged that it could be carried out on either of the embodiments of FIG. 1 or FIG. 7.

When the hinged panel 210 is folded out of the plane of the bottom panel 230, it creates a recess; in alternative embodiment, an aperture may be formed. The securing panel 220 is exposed through the aperture or recess, allowing glue or other adhesive to be applied to the securing panel 220 through the aperture or recess.

It will be appreciated that various changes may be made within the scope of the present invention, for example, the size and shape of the panels and apertures may be adjusted to accommodate articles of differing size or shape. In other embodiments of the invention, it is envisaged that a greater number of articles may be packaged in alternative array shapes. It is also envisaged that in an alternative embodiment, the blank may be secured by alternative means such as conditioning, such as by application of heat, light or chemicals, to the blank or part thereof to give it adhesive properties. In the preferred embodiments such as illustrated in FIG. 7, the securing panel 120 may be dimensioned such that its depth, i.e., the dimension “D” between the hinged connection 119 and the free edge 151 opposing the hinged connection 119 is less than the width “W” of the hinged panel 110, i.e., the distance between the hinged connection 111 and the free edge 173 of the hinged panel 110 opposing the hinged connection 111. However, in alternative embodiments, it is envisaged that the depth of the securing panel may be greater than the depth of the hinged panel.

It will be recognised that as used herein, directional references such as “top”, “bottom”, “front”, “back”, “end”, “side”, “inner”, “outer”, “upper” and “lower” do not limit the respective panels to such orientation, but merely serve to distinguish these panels from one another. Any reference to hinged connection should not be construed as necessarily referring to a single fold line only; indeed it is envisaged that hinged connection can be formed from one or more of the following, a short slit, a frangible line or a fold line without departing from the scope of the invention.

1. A carton for packaging articles comprising a plurality of main panels hinged together to form a tubular structure wherein said main panels include first and second adjoining panels, said first panel is hinged to a securing panel and said second panel comprises a hinged panel struck therefrom and hingedly connected thereto, said hinged panel being foldable out of the plane of the second panel to facilitate alignment of said second panel with respect to the securing panel and to facilitate securing of the hinged panel to the securing panel.

2. A carton according to claim 1 wherein the securing panel is adhesively secured to the hinged panel only.

3. A carton according to claim 1 wherein edges of the second panel provide a positioning device for aligning the first panel with the second panel.

4. A carton according to any of claim 1 wherein the hinged panel is substantially trapezoidal in shape.

5. A carton according to any of claim 1 wherein the hinged panel is substantially hexagonal in shape.

6. A carton according to claim 1, wherein the securing panel is hingedly connected to the first panel along a first fold line, the hinged panel is hingedly connected to the second panel along a second fold line, and the first fold line is substantially greater in length than the second fold line.

7. A carton according to claim 1 wherein the hinged panel is struck from the second panel such that at least one guide edge is provided by the second panel, said at least one guide edge is disposed substantially in the plane of the first panel.

8. A carton according to claim 7 wherein said at least one guide edge is disposed in substantial alignment with a fold line along which said securing panel is hinged to said first panel.

9. A carton according to claim 7 wherein said at least one guide edge is substantially parallel to a fold line along which said hinged panel is connected to said second panel.

10. A carton according to claim 7 wherein said at least one guide edge comprises a pair of spaced guide edges, and said hinged panel is interposed between said pair of spaced guide edges.

11. A carton according to claim 10 wherein said hinged panel is connected to said second panel along a fold line, said pair of spaced guide edges are connected to said fold line by a pair of divergent edges of said second panel that are defined at least in part by said hinged panel.

12. A blank for forming a carton comprising a plurality of main panels hinged together in a row so that a tubular structure may be formed from said main panels by interconnecting first and second panels of said main panels at opposite ends of said row, wherein said first panel is hinged to a securing panel and said second panel comprises a hinged panel struck therefrom and hingedly connected thereto, said hinged panel being foldable out of the plane of the second panel for facilitating alignment of said second panel with respect to the securing panel and for facilitating securing of the hinged panel to the securing panel.

13. A blank according to claim 12 wherein the hinged panel is substantially trapezoidal in shape.

14. A blank according to claim 12 wherein the hinged panel is substantially hexagonal in shape.

15. A method of constructing carton about a group of one or more articles to form a package, the carton being formed from a blank comprising a securing panel, a first side wall, a top panel, a second side wall and a bottom panel hinged together in the recited sequence, the bottom panel including a hinged panel struck therefrom and hinged thereto, the method comprising:
offering said blank up to a group of one or more articles such that the top panel is brought into contact with one of opposed end surfaces of said group of one or more articles;
folding the first side wall and the second side wall onto opposed sides of said group of one or more articles so that the blank is formed into a substantially U-shaped structure;
folding the securing panel onto the other of the opposed end surfaces of the group of one or more articles;
folding the hinged panel out of the plane of the bottom panel;
folding the bottom panel onto the other opposed end surface of the group of one or more articles;
aligning the bottom panel with respect to the securing panel;
conditioning the securing panel or the hinged panel such that the hinged panel is secured to the securing panel;
folding the hinged panel back into the plane of the bottom panel to be brought into contact with the securing panel thereby securing the main panels of the blank in a tubular structure.

16. A method of constructing carton according to claim 15 wherein the step of conditioning the securing or hinged panel comprises applying adhesive material to the securing panel or the hinged panel.

17. A method of constructing carton according claim 15 wherein folding of said hinged panel out of the plane of the bottom panel creates a window through which adhesive may be applied to the securing panel.

18. A method of constructing carton about a group of one or more articles to form a package, the carton being formed from a blank comprising a securing panel, a first side wall, a top panel, a second side wall and a bottom panel hinged together in the recited sequence, the bottom panel including a hinged panel struck therefrom and hinged thereto, the method comprising:
folding the bottom panel to be substantially perpendicular to the first side wall;
folding the hinged panel out of the plane of the bottom panel;
lowering a group of one or more articles onto the base panel;
folding the top panel and the second side wall about the group of one or more articles;
folding securing panel onto the base of the group of one or more articles;
aligning the bottom panel with respect to the securing panel;
conditioning the securing panel or the hinged panel such that the hinged panel is secured to the securing panel;
folding the hinged panel back into the plane of the bottom panel so that the hinged panel is brought into contact with the securing panel whereby the main panels of the blank are formed into a tubular structure.

19. A method of constructing carton according to claim 18 wherein said hinged panel is folded into a substantially vertical position for application of adhesive thereto.

20. A method of constructing carton according to claim 19 wherein adhesive is applied such that only the hinged panel is secured to the glue flap.
